(19) United States
(12) Patent Application Publication
(10) Pub. No.: US 2025/0156664 A1
(43) Pub. Date: May 15, 2025

(54) INK JET PRINTER CALIBRATION

(71) Applicant: Kateeva, Inc., Newark, CA (US)

(72) Inventors: Eashwer Chandra Vidhya Sagar Kollata, Newark, CA (US); David C. Darrow, Newark, CA (US)

(73) Assignee: Kateeva, Inc., Newark, CA (US)

(21) Appl. No.: 18/839,382

(22) PCT Filed: Feb. 21, 2023
(86) PCT No.: PCT/US2023/062913

§ 371 Date: Aug. 16, 2024

Related U.S. Application Data
(60) Provisional application No. 63/268,357, filed on Feb. 22, 2022.

(51) Int. Cl. G06K 15/02; B29C 64/112; G06T 7/00

(52) U.S. Cl. CPC G06K 15/027; B29C 64/112; G06T 7/0002; G06T 2207/30144

(57) ABSTRACT

A manufacturing system includes a dispenser unit movably coupled to a support, the dispenser unit comprising a location sensor and a reference detector; a test unit comprising a surface for receiving material from the dispenser unit and an imaging device for imaging the material on the surface; a location reference mounted to a stationary component of the manufacturing system; and a controller configured to control the dispenser unit and the reference detector to detect the location reference; calibrate a position of the dispenser unit based on detecting the location reference; control the test unit to image the material on the surface; control the dispenser unit and the reference detector to detect an aspect of the material on the surface; compare the image of the material captured by the test unit with the aspect of the material detected by the reference detector; and calibrate the test unit based on the comparison.

### CROSS-REFERENCE TO RELATED APPLICATIONS

This application claims benefit of U.S. Provisional Patent Application Ser. No. 63/268,357 filed Feb. 22, 2022, which is entirely incorporated herein by reference.

### BACKGROUND

Precision manufacturing methods that include precisely placing material on a work piece use positioning devices to detect the position of components that require precision positioning. The positioning devices require calibration. Where multiple positioning devices are used in a complex manufacturing process involving a single work piece, the positioning devices frequently need to be calibrated to a single position standard, for example a global coordinate system for the manufacturing system. Often, a manufacturing method involves dispensing a material onto the work piece, which may be performed by more than one dispenser. Where all the dispensers need to be precisely positioned, and to precisely dispense the material, operation of the dispensers must be calibrated, with precision, to the single position standard. Examples of such manufacturing systems include devices that can be regarded as printers, including industrial scale inkjet printers and coaters, 3D printers, and other liquid droplet or stream dispensing systems. Methods and apparatus are needed for fast, robust calibration of such systems.

### SUMMARY

Embodiments described herein provide a manufacturing system, comprising a dispenser unit movably coupled to a support, the dispenser unit comprising a location sensor and a reference detector; a test unit comprising a test surface for receiving material from the dispenser unit and an imaging device for imaging the material on the test surface; a location reference mounted to a stationary component of the manufacturing system; and a controller configured to control the dispenser unit and the reference detector to detect the location reference; calibrate position of the reference detector based on detecting the location reference; control the test unit to image the material on the test surface; control the dispenser unit and the reference detector to detect an aspect of the material on the test surface; compare the image of the material captured by the test unit with the aspect of the material detected by the reference detector; and calibrate the test unit based on the comparison.

Other embodiments described herein provide a method of operating an inkjet printer, the method comprising using a first imaging device of and inkjet printer to capture a first image of a print material deposited on a test surface of the inkjet printer; using a second imaging device of the inkjet printer to capture a second image of the print material on the test surface; resolving a first position of the print material from the first image; resolving a second position of the print material from the second image; resolving a transformation of the first position to the second position; using the test imaging device to capture a third image of a plurality of dots printed by the inkjet printer on the test surface; resolving a first position of a dot of the plurality of dots from the third image; and resolving a second position of the dot by applying the transformation to the first position of the dot.

Other embodiments described herein provide a method, comprising using a first imaging device of a manufacturing system to image a test material deposited on a test surface of the manufacturing system by a dispenser unit of the manufacturing system; concurrently with using the first imaging device to image the test material, using a second imaging device of the manufacturing system to image a feature on a work piece disposed on a work piece support of the manufacturing system; calibrating the first imaging device by comparing a first image, captured by the first imaging device, of a calibration material deposited on the test surface with a second image of the calibration material captured by a third imaging device of the manufacturing system coupled to the dispenser unit; calibrating the second imaging device based on a location reference of the manufacturing system; and calibrating the third imaging device based on the location reference.

### BRIEF DESCRIPTION OF THE FIGURES

FIG. 1 is a plan view of an additive manufacturing system according to one embodiment.

FIG. 2 is a plan view of an ink jet printer according to one embodiment.

FIG. 3 is a flow diagram summarizing a method according to one embodiment.

FIGS. 4A and 4B are flow diagrams summarizing portions of a method according to another embodiment.

### DETAILED DESCRIPTION

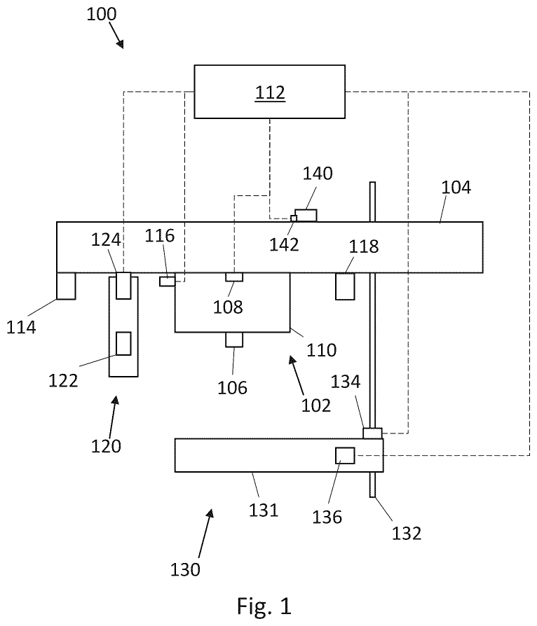

FIG. 1 is a schematic plan view of an additive manufacturing system 100. The additive manufacturing system 100 generally works by adding material to a work piece according to precise tolerances, which may be as fine as 1 μm. A dispenser unit 102 is movably disposed on a support 104 with a work piece support 130 beneath for positioning a work piece to receive material from the dispenser unit 102. The dispenser unit 102 is typically positioned with extreme precision to dispense material onto the work piece at a desired location, also with extreme precision. The dispenser unit 102 includes a dispenser 106 and a location sensor 108 attached to a body 110 that may be a mount, housing, or other component of the dispenser unit 102. The dispenser 106 and the location sensor 108 are thus in a fixed positional relationship one to the other (ignoring thermal variations, for the moment). In order to position the dispenser unit 102 such that the dispenser 106 is at a desired location, a controller 112 typically receives signals from the location sensor 108, and resolves the location of the location sensor 108 from the signals. The location of the dispenser 106 can be resolved from the location of the location sensor 108 by applying a constant offset, since the dispenser 106 and the location sensor 108 are attached to the same object.

The controller 112 needs a calibration function Xₛ=f(s) to resolve the location of the location sensor 108 Xₛ from the signals s, and in many cases micron-scale errors cannot be tolerated. A location reference 114 is attached to the support 104 at a location accessible to the dispenser unit 102 by moving the dispenser unit 102 along the support 104. The dispenser unit 102 includes a reference detector 116 attached to the body 110 to detect the location reference 114. To define the calibration function, the dispenser is moved to a calibration position where the reference detector 116 can detect the location reference 114. The reference detector 116 sends a signal to the controller 112 representing the location of the location reference 114 in a coordinate system of the reference detector 116. The controller 112 applies the known position of the location reference 114 to resolve the exact position of the reference detector 116. The controller 112 uses the known, fixed position of the reference detector 116 and the location sensor 108 to define the function f(s) so that the position of the dispenser 106 can be known precisely at all times.

The location sensor 108 can be an encoder in some cases. The reference detector 116 can be a detector that uses electromagnetism, such as an electric, magnetic, or electromagnetic detector. The reference detector 116 can be a high magnification camera capable of resolving details at the micro scale. The location reference 114 can be a reticle, or similar object for precision imaging, to use with the high magnification camera. In such cases, the controller 112 controls the reference detector 116 to capture an image of the location reference 114, and image processing software processes the image to resolve a position in the local coordinate system (the coordinate system of the reference detector 116). The reference detector 116 can include a light source (not shown) that can be adapted as necessary to the needed precision of the system.

The location reference 114 is generally mounted to a stationary component of the manufacturing system to provide a standard location for calibrating location sensors using reference detectors that can be moved to reach the location reference 114. Where location sensors need calibrating using tools that cannot reach the location reference 114, where such tools can, along with a reference detector, commonly analyze an object, such tools can be calibrated using the calibration of a reference detector. Such calibration method amounts to using calibrants traceable to a standard. A reference detector is located using location sensors calibrated using the location reference 114 as a standard location. Tools that cannot reach the location reference 114 can be located by using the calibration of the reference detector by performing an analysis in common with the reference detector to establish a calibration relationship with the reference detector.

Thermal variation can introduce errors large enough to disrupt precision positioning equipment. So long as temperature remains relatively constant, the calibration function f(s) remains accurate. Temperature variation, however, can introduce problematic errors in determining positon of the location sensor 108. In some cases, such errors can be captured by providing a second location reference 118 attached to the support 104, with the location reference 114, which in such cases is a first location reference, at one extremity of the movement range of the dispenser unit 102 and the second location reference 118 at the other extremity of the movement range. Here, the location references 114 and 118 are located at a z-location that enables the dispenser unit 102 to move along the support 104 without interference from the location references 114 and 118. Imaging the two location references 114 and 118 using the reference detector 116, and mapping the signals of the location sensor 108 to the resolved positions can reduce the errors inherent to thermal variation because a calibration curve Xₛ=f(s, T) can be defined as a function of the location sensor signal and temperature by capturing calibration points of the location sensor at the two extremities of the motion range of the dispenser unit 102 at different temperatures. Such methods naturally require temperature measurement.

In some cases, performance of the dispenser 106 can vary. In such cases, a test unit 120 can be provided to analyze performance of the dispenser 106. The test unit 120 has hardware for detecting characteristics of material dispensed from the dispenser 106. For example the test unit 120 can have a test surface 122 to receive dispensed material and an imaging device 124 to capture an image of the dispensed material and resolve characteristics of the dispensed material from the image. For such purposes, the position of the dispensed material in the capture image is often used. To resolve dispenser performance characteristics from such data, the position of the dispenser 106 when material was dispensed onto the test surface 122 and the position of the dispensed material on the test surface 122 must be precisely determined with respect to a common location reference or coordinate system.

The position of an image of dispensed material on the test surface 122, reported by the imaging device 124, can be related to the position of the dispenser 106 using a camera attached to the dispenser unit 102. The camera can be the reference detector 116 or another camera attached to the body 110 (with fixed offset from the other components attached to the body). Where the reference detector 116 is a high magnification camera, the dispenser unit 102 can be positioned to dispense material onto the test surface 122, an image of the dispensed material can be captured by the imaging device 124, and an image of the dispensed material can be captured by the reference detector 116. Positions of features of the dispensed material, such as a droplet or portion of a droplet on the test surface 122, can be resolved using both images, and the exact positon of the imaging device 124 in the global coordinate system of the manufacturing system can be determined. Subsequently, the position of dispensed material in relation to the dispenser 106 can be resolved with precision using the imaging device 124, and a relationship of dispenser 106 operation to location of dispensed material can be developed with precision so that positioning and operation of the dispenser 106 can be planned.

The manufacturing system 100 can have a work piece support 130 that positions a work piece for interoperation with the dispenser unit 102 so that the dispenser unit 102 can deposit material onto the work piece. The work piece support 130 is shown here schematically because the work piece support 130 can be any type of support. The work piece support 130 has a support member 131 movably disposed on a positioner 132 so that the work piece support 130 can move the work piece with respect to the dispenser unit 102. The work piece support 130 has a location sensor 134, which can be an encoder or another sensor, to signal the location of the work piece support 130 to the controller 112. A reference detector 136, which in this case is a second reference detector where the reference detector 116 is a first reference detector, is provided in a fixed position relative to the support member 131. The reference detector 136 can be any type of electric, magnetic, or electromagnetic detector. In this case, the reference detector 136 is a camera, which can be a high magnification camera.

The work piece support 130 can be moved to place the second location reference 118 within the field of view of the reference detector 136 so the reference detector 136 can capture an image of the second location reference 118. It should be noted that the positioner 132 can be disposed at any convenient location of the manufacturing system 100. The reference detector 136 is implemented here in a position that allows the reference detector 136 to interoperate with the second location reference 118, but the reference detector 136 could be implemented in a position for interoperation with the first reference detector 116. The reference detector 136 captures an image of the location reference 118, and a digital processing system uses imaging processing to determine a location of a feature of the location reference 118 in a coordinate system of the reference detector 116.

The reference detector 116 has a known displacement from the location sensor 134, so the controller 112 can compare the signal from the location sensor 134, received at the time the work piece support 130 is positioned with the second location reference 118 within the field of view of the reference detector 116, with the location of the feature of the second location reference 118 resolved by the reference detector 136 to define a calibration function for the location sensor 134 in the global coordinate system of the manufacturing system 100. The calibration function can be used by the controller 112 to resolve the precise location of work piece support 130 from the signal of the location sensor 134.

The work piece is positioned on the work piece support 130 for processing by the manufacturing system 100. In order to precisely place material from the dispenser 106 onto the work piece, the exact location of the work piece on the work piece support 130 must be known. In some cases, even providing a holder of some sort to hold every work piece in exactly the same position may not ensure that micro-scale errors in positioning and/or orienting the work piece do not cause processing errors. The manufacturing system can use a work piece detector 140 to detect the work piece disposed on the work piece support 130 and to detect the exact position and/or orientation of the work piece on the work piece support 130. The work piece detector 140 may be a camera that captures an image of the work piece, or a feature or the work piece, to ascertain the position and/or orientation of the work piece on the work piece support.

For the position of the work piece to be known precisely in the global coordinate system of the manufacturing system 100, the precise position of the work piece detector 140 must be known. The work piece detector 140 can be mounted on any convenient support. In this case, the work piece detector 140 is movably mounted to the support 104. The work piece detector 140 can be mounted at a z-location that allows the dispenser unit 102 to move along the support 104 without interference from the work piece detector 140. In this case, the work piece detector 140 is mounted to the support 104 on a first side of the support 104 while the dispenser unit 102 is mounted to a second side of the support 104, opposite from the first side. The work piece support 130 can move the work piece to a position with respect to the work piece detector 140 such that a feature of the work piece is within the field of view of the work piece detector 140. The work piece detector 140 images the feature, and image processing is used to determine a precise location of the feature within a coordinate system of the work piece detector 140. The work piece detector 140 has a location sensor 142, such as an encoder, that signals the location of the location sensor 142 to the controller 112. The global location of the location sensor 142 can be calibrated using one or both of the location references 116/118, as above, so the exact position of the work piece detector 140 can be ascertained by the controller 112. The exact position of the work piece on the work piece support 130 can then be ascertained by the controller 112.

The manufacturing system 100 thus calibrates the location of the dispenser 106, the location of the imaging device 124, the location of the work piece support 130, and the location of the work piece with respect to the work piece support 130 in a global coordinate system of the manufacturing system 100. In this way, the controller 112 can receive signals from the location sensors 108 and 134, and can resolve the precise positions of the dispenser 106 and the work piece supported on the work piece support 130, and can accurately predict where the dispenser 106 will deposit material when activated, all in a unified coordinate system. The manufacturing system 100 is able to calibrate each sensor and imaging device to the unified coordinate system using either stationary location references or by detecting the same feature using a reference detector, whose position is calibrated using a stationary location reference, and a detector to be used in operation and by comparing the signals from the two detectors. That is to say, where a stationary location reference cannot be used to calibrate a sensor, a non-stationary reference can be used by detecting the reference using a reference detector calibrated to a stationary location reference, and the signal of the reference detector can be used as a calibration reference.

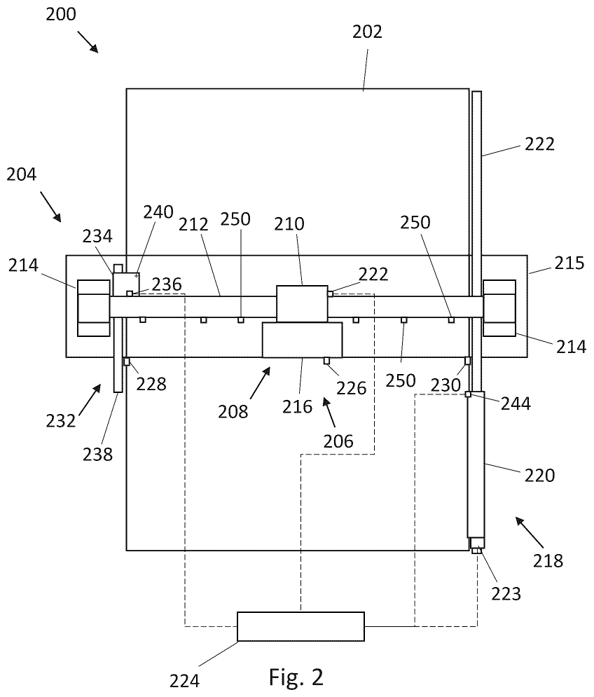

FIG. 2 is a plan view of an inkjet printer 200 that includes versions of the features described in respect to FIG. 1. The printer 200 has a substrate support 202 to support a printing substrate. A print support 204 is disposed across the substrate support 202 from one side thereof to an opposite side thereof. The substrate support 202 extends longitudinally to provide support for the substrate to move with respect to the print support 204. A print assembly 206, comprising a print head assembly 208 and a motion system 210, is coupled to the print support 204. The print support 204 comprises a print assembly support 212 that extends across the substrate support 202, in a transverse direction of the substrate support 202, and two stands 214, which support the print assembly support 212 at either side of the substrate support 202. The print assembly 206 is coupled to the print assembly support 212 by the motion system 210, which allows the print assembly 206 to move along the print assembly support 212 in the transverse direction of the substrate support 202. The substrate support 202 and the stands 214 of the print support 204 may be supported on a base 215 to reduce transmission of ambient movement to the substrate support 202 and the print support 204.

The print head assembly 208 has a housing 216 that contains print heads (not visible) for dispensing print material onto a substrate. The print heads have nozzles that are exposed at a surface of the housing 216 that faces the substrate support 202. The housing 216 also contains print material delivery, as well as pneumatic and electric devices for controlling ejection of print material from the nozzles.

In this embodiment, the substrate support 202 is a floatation support that supports a substrate on a gas cushion for substantially frictionless motion. The floatation support allows the substrate to be moved and positioned with respect to the print support 204 and the print assembly 206.

At one side of the substrate support 202 is a substrate holder assembly 218. The substrate holder assembly 218 includes a substrate holder 220 and a holder support 222. The holder support extends along the side of the substrate support 202 in the longitudinal direction of the substrate support 202, and the substrate holder 220 is movably coupled to the holder support 222 to move along the holder support 222. The substrate holder 220 engages with a substrate to hold the substrate in a desired position and to move the substrate to a desired location on the substrate support 202. The motion system 210 moves the print head assembly 208 in a transverse direction of the substrate support 202 while the substrate holder assembly 218 move the substrate in the longitudinal direction of the substrate support 202. In this way, all location of the substrate can be accessed by the print head assembly 208 for processing.

Precise placement of print material on a substrate relies upon precise movement and placement of the print head assembly and the substrate. A controller 224 has a digital processing system configured to control actuators of the motion system 210 and the substrate holder assembly 218 to accomplish deposition of material on a substrate. The motion system 210 has a first location sensor 223 and the substrate holder has a second location sensor 223. Each location sensor 223 and 223 may be an encoder, and each is operatively coupled to the controller 224 to send signals representing location of the motion system 210 and the substrate holder 220, respectively.

The digital processing system of the controller 224 is configured to interpret signals from the location sensors of the motion system 210 and the substrate holder 220 to determine the locations thereof, to determine desired movements of the motions system 210 and the substrate holder 220 based on the determined locations and on a print plan that has desired locations for depositing print material on the substrate, and to output signals to the motion system 210 and the substrate holder 220 to accomplish movements and deposition of material on the substrate. In order to accurately and precisely position the substrate and the print head assembly and dispense print material, the configuration of the controller 224 must include a calibration function to resolve locations of the motion system 210 and the substrate holder 220 from the received signals.

A high magnification camera 226 is attached to the housing 216 for calibrating the controller 224 to the location sensor of the motion system 210. The high magnification camera 226 has a field of view that extends toward the substrate support 202. Because the high magnification camera 226 is attached to the housing at a fixed displacement from the location sensor 223 of the motion system 210, an image can be captured by the high magnification camera 226, image processing software can locate a feature of the image within a coordinate system of the high magnification camera 226, and the location of the feature of the image with respect to the location sensor 223 of the motion system 210 can be determined by adding the fixed displacement of the high magnification camera 226 from the location sensor 223 to the coordinates of the imaged feature determined in the coordinate system of the high magnification camera 226. If the object imaged by the high magnification camera 226 is fixed to the superstructure of the printer 200, then the image can serve to precisely and accurate locate the location sensor 223 in a global coordinate system of the printer 200. Relating that absolute location to the signal obtained from the location sensor 223 at the time the image is taken provides a calibration coefficient or calibration function for the controller 224 to translate signals from the location sensor 223 into location coordinates in the global coordinate system of the printer 200.

A location reference 228 is therefore attached to a stationary component of the printer 200 at a location that can be imaged by the high magnification camera 226. The location reference is an object that can be imaged by the high magnification camera 226 to ascertain precise coordinates for a feature of the image. The location reference 228 may include a reticle, for example. The location reference 228 is attached to a stationary component of the printer 200, such as one of the stands 214, the print assembly support 212, the substrate support 202, or the base 215, in a position and orientation such that the print assembly 206 can move along the print assembly support 212 and place the location reference 228 within the field of view of the high magnification camera 226. The controller 224 is configured to control the motion system 210 to move the print assembly 206 to bring the location reference 228 within the field of view of the high magnification camera 226, and to control the high magnification camera 226 to capture an image of the location reference 228, or of an image standard of the location reference 228, such as a reticle. The controller 224, or another digital processing system, is configured to apply image processing techniques to resolve a precise location of a feature of the image within a coordinate system of the camera 226. The controller 224 is configured with the known position of the location reference 228, and is configured to compute a coefficient using the signal from the location sensor of the motion system 210 sampled at the time the image of the location reference 228 was taken and using the coordinates of the image resolved by the image processing techniques to define the calibration function for the location sensor of the motion system 210. In this way, the controller 224 is then able to translate signals from the motion system 210 location sensor into global coordinates.

A second location reference 230 can be attached to one of the stationary components of the printer 200 to improve the calibration. In such cases, the location reference 228 is a first location reference. The second location reference 230 can be attached at a location relatively far from the first location reference 228 in order to provide maximum improvement of the calibration, and also to provide calibration support for other components of the printer 200. In this case, both the first and second location references 228 and 230 are attached to the base 215, at opposite sides of the substrate support 202, and are both oriented to provide access by the high magnification camera 226. The same calibration procedure can be performed using the high magnification camera 226 and the second location reference 230 to refine the coefficient for translating signals of the location sensor 223 into global coordinates. If desired, a temperature sensor can be provided on the printer 200 to give temperature data for relating to the coefficient computed for the location sensor 223. Calibrating at different temperatures can provide a calibration function that converts signals of the location sensor 223, along with signals from a temperature sensor, to global location coordinates.

The print heads of the print head assembly 208 dispense print material through nozzles. Droplets of print material are ejected from the nozzles to deposit on a substrate. To deposit the droplets at a desired location on the substrate with accuracy and precision, performance of the nozzles, how the droplets travel and arrive at the substrate after being ejected from the nozzle, must be ascertained. That is, a function must be defined that yields the location of a landed droplet on a substrate z units from the nozzle in the z-direction of the global coordinate system when the droplet is ejected from a nozzle, using a certain stimulus, located at a known coordinate in the global coordinate system.

To ascertain that function, which is a calibration function of the print head assembly (i.e. each nozzle of the print head assembly 208, paired with each possible stimulus of the nozzle, has a calibration function that yields location of a landed droplet as a function of nozzle position), a droplet placement analyzer 232 is used. The droplet placement analyzer 232 is a device that provides a surface to receive droplets of print material ejected from nozzles of the print head assembly 208 along with an analyzer 236, such as a high magnification camera, to resolve characteristics of the deposited droplet. The droplet placement analyzer 232 can be located anywhere on the printer 200 accessible by the print assembly 206. In this case, the droplet placement analyzer 232 is located at a side of the substrate support 202, on the base 215 near one of the stands 214, opposite from the substrate holder assembly 218. Thus, the droplet placement analyzer 232 and the substrate holder assembly 218 are on opposite sides of the substrate support 202. The analyzer 236 is mounted to the print assembly support 212 on a side thereof opposite from a side of the print assembly support 212 along which the housing 216 is disposed. The droplet placement analyzer 232 can include a positioner 238, to which the surface 234 can be movably coupled to provide motion for the surface 234. The analyzer 236 can also be disposed on a positioner to allow the analyzer 236 to access droplets deposited at various locations on the surface 234.

When a test is performed on the print head assembly 208 using the droplet placement analyzer 232, locations of the nozzles of the print head assembly 208 are known in global coordinates, since the controller 224 has a calibration function to transform signals of the location sensor 223 into the global coordinate system of the printer 200. The droplet placement analyzer 232 is configured to resolve a position of a droplet disposed on the receiving surface 234. The position is resolved in a coordinate system of the droplet placement analyzer 232. To relate the position of the deposited droplet to the position of the nozzle that dispensed the droplet, the coordinate system of the droplet placement analyzer 232 must be transformed to the global coordinate system. In this case, the analyzer 236 used to record the position, or other features, of the droplet deposited on the surface 234 cannot be directly calibrated to either of the location references 228 or 230. To calibrate signals from the analyzer 236 to the global coordinate system, the droplet placement analyzer 232 and the high magnification camera 226 are used to image the same deposited droplet and resolve the position of the deposited droplet. The receiving surface 234 has a reference location feature 240, such as a mark, that can be used to locate a deposited droplet in coordinate systems of the high magnification camera 226 and the droplet placement analyzer 232, and a simple transformation, based on the positions of the droplet in the two coordinate systems, can yield position of a droplet in the global coordinate system when that position is known in the coordinate system of the droplet placement analyzer 232.

With the features described so far, location of nozzles of the print heads of the print head assembly 208 can be precisely known in global coordinates using the calibration function of the location sensor 223 and the position of droplets deposited on a substrate from each nozzle, using the various available stimuli, can be precisely known in global coordinates using the transformation of the droplet placement analyzer coordinate system to the high magnification camera coordinate system.

Substrate position can be precisely determined using a calibration function derived from signals of a location sensor coupled to the substrate holder assembly 218 and operatively coupled to the controller 224. A high magnification camera 244 is coupled to the substrate holder assembly 218 in a way that allows the substrate holder assembly to bring the high magnification camera 244 to a position that captures the second location reference 230 in its field of view. The high magnification camera 244 can image the second location reference 230 and derive a calibration function for the location sensor 223 of the substrate holder assembly 218 in a manner similar to the other moving components described above. The position of the substrate holder assembly 218 can thus be ascertained by the controller 224 with accuracy and precision. If desired, a third location reference can be used to diminish thermal errors associated with the position of the substrate holder assembly 218, as described above.

Finally, as a substrate is positioned on the substrate support 202 for processing, various errors can attend the positioning of the substrate as well as structures on the substrate that relate to the print plan for the substrate. For example, if a prior process formed structures on a substrate with some error in position of layout of the structures, that error needs to be accounted for in the print plan for the substrate. Likewise, if the substrate is slightly out of position, or has a slightly imperfect orientation when placed on the substrate support 202, that error needs to be accounted for in the print plan as well. These errors are usually ascertained and compensated using standard marks on the substrate itself. A camera is typically used to image the standard marks, and image processing is applied to ascertain any position and orientation errors of the substrate on the substrate support 202. Similar methods can be used to ascertain prior assembly errors.

The high magnification camera 226 can be used to ascertain the precise position and orientation of marks on a substrate. The controller 224 controls the substrate holder assembly 218 to position the substrate at a location likely to bring a calibration feature of the substrate into the field of view of the high magnification camera 226 for imaging based on a print plan of the substrate provided to the controller 224. The controller 224 controls the motion system 210 to position the print head assembly 208 so the field of view of the high magnification camera 226 encompasses a region likely to host the calibration feature of the substrate. The controller controls the high magnification camera 226 to image the portion of the substrate within the field of view of the camera 226, and image processing is used to determine the precise location of the calibration feature of the substrate in the coordinate system of the camera 226. The controller 224 transforms the coordinates of the calibration feature to global coordinates using the calibration function of the camera 226. The controller 224 can then use information of the print plan of the substrate to identify any other location of the substrate, such as a corner or center, based on the detected position of the calibration mark. These locations can be transformed to any other location using signals of the various calibrated sensors of the printer 200.

Substrate detection and calibration can be expedited using multiple imaging devices to image calibration marks on the substrate. For example, where a plurality of products are to be sourced from one substrate, the substrate may have a plurality of calibration or alignment marks to indicate the various boundaries of the products. The printer 200 has a plurality of calibration imaging devices 250 for calibrating the printer to the position and layout of the substrate disposed on the substrate support 202. The imaging devices 250 are supported on the print assembly support 212 in a way that does not impede movement of the print assembly support 212. For example, the imaging devices 250 may be supported from a bottom of the print assembly support 212. Providing a plurality of imaging devices to image and locate a plurality of calibration and/or alignment marks on a substrate speeds up the calibration process. The imaging devices 250 can be low magnification cameras, high magnification cameras, or a mixture thereof. The imaging devices 250 can also be, or include, line image scanners.

In order to resolve the positions and orientations of calibration and/or alignment marks of a substrate using a plurality of imaging devices, each of the imaging devices 250 must be precisely calibrated to the global coordinate system of the printer 200. Where the imaging devices 250 are configured to be moved to a position to image one or both of the location references 228 and 230, the imaging devices 250 can be directly calibrated. Each imaging device 250 images the location reference and resolves the precise position of a feature of the location reference in the coordinate system of the imaging device 250. Each of the imaging devices 250 has a location sensor, like the location sensor 223, which signals the precise position of the imaging device 250 to the controller 224. The controller 224 relates the signal of the location sensor to the position of the feature of the location reference resolved by the imaging device 250 to ascertain a calibration function or coefficient.

As shown here, the imaging devices 250 cannot be moved to capture an image of either of the location references 228 or 230, so the imaging devices 250 must be calibrated using the calibration of another device that can be calibrated directly using the location references 228 or 230. In this case, the high magnification camera 226 can be used. Each of the imaging devices 250 images a feature on the substrate, such as a calibration or alignment mark, and the high magnification camera 226 images the same feature. The precise position of the feature can be known from the calibration of the high magnification camera 226. The position of the feature reported by each imaging device 250 can be compared to the known position from the camera 226 to define a relationship between a position ascertained by the imaging device 250 and the global coordinate system. Henceforth, the imaging devices 250 can be controlled by the controller 224 to ascertain the positions and orientations of calibration and alignment marks on a substrate in the global coordinate system.

The controller 224 is thus configured to directly and indirectly calibrate all location sensors of the printer 200 to the global coordinate system of the printer 200 based on the location references 228 and 230, and based on calibration of the high magnification camera 226 using the locations references 228 and 230. The indirect calibration is performed by imaging the same object using a camera coupled to the location sensor to be calibrated and using the high magnification camera 226, resolving a position of the object using both images, and comparing the resolved positions to define a transformation for the signal from the location sensor being calibrated to the global coordinate system.

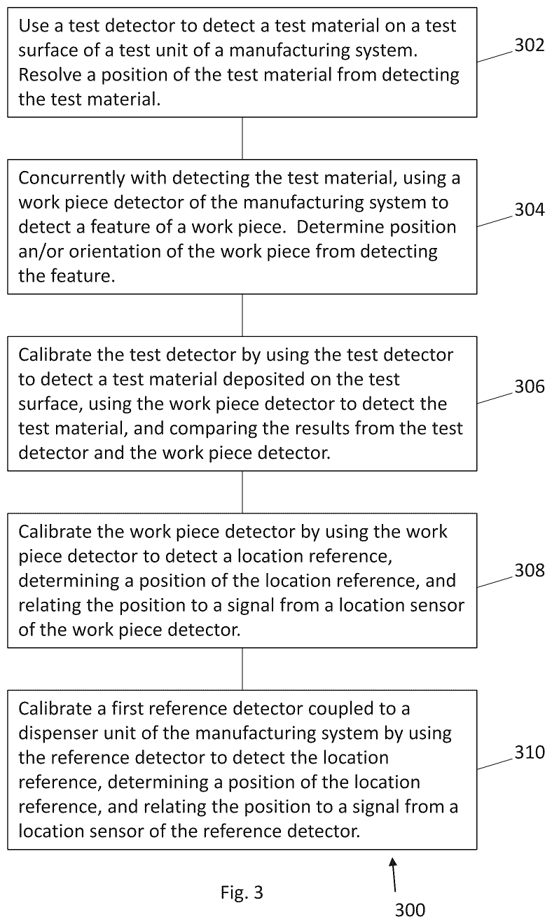

FIG. 3 is a flow diagram summarizing a method 300 according to one embodiment. The method 300 is a method of operating a manufacturing system that comprises a dispenser unit movably coupled to a support, a work piece support movably disposed to position a work piece for processing by the dispenser unit, and a test unit having a test surface for receiving test material from the dispenser unit and a test detector for detecting an aspect of the test material, for example an imaging device to image the test material or a portion thereof, to resolve a performance characteristic of the dispenser unit. The test detector has a test location sensor to output a signal representing position of the test detector. The dispenser unit has a dispenser location sensor to output a signal representing the position of the dispenser unit on the support. The dispenser unit also has a first reference detector that can be used to define a position of the dispenser unit based on the signal of the first location sensor. The work piece support also has a work piece support location sensor to output a signal representing the position of the work piece support, and a second reference detector that can be used to define position of the work piece support based on the signal from the work piece support location sensor. A work piece detector is also movably coupled to the support to detect a work piece, or a feature of a work piece. The work piece detector has a work piece detector location sensor to output a signal representing the position of the work piece detector. The various detectors can be imaging units or systems with cameras, photodiode arrays, line sensors, or other devices that can render an image using any suitable energy medium to provide precision in detecting positions.

The manufacturing system can have one or more controllers that use digital processors to control various components and operations of the manufacturing system and to collect signals from the various sensors and detectors of the manufacturing system. A single controller can control the entire manufacturing system, or each subsystem, such as the test unit, the dispenser unit, and the work piece support, can have a dedicated controller, and a system controller can interact with the subsystem controllers in a hierarchy to control the manufacturing system.

At 302, the test detector is used to detect the test material on the test surface. The test detector may be a camera, or other imaging device, to capture an image of the test material so that image processing can be used to resolve a position of the test material. Other aspects of the test material, such as thickness, spread, and uniformity can be ascertained as well from the image of the test material. In some cases, the test material may cover an area of the test surface that exceeds a range of the detector, for example a field of view, and in such cases multiple images or signatures of the test material can be gathered by the test detector and can be processed individually, sequentially, or concurrently, and may be integrated into a single image or signature of the test material. The test performed at 302 is to define performance of the dispenser unit used to deposit the test material. For example, the position of test material ejection from the dispenser unit can be ascertained and compared to position of the test material on the test surface to resolve how material dispensed from the dispenser unit arrives at a substrate. Using such information, ejection of material from the dispenser unit to a work piece can be planned and executed with precision. The controller of the manufacturing system, or the controller of the test unit, can be configured to control the test unit to perform the operations of part 302.

At 304, concurrently with detecting the test material on the test substrate, the work piece detector is used to detect a feature of a work piece disposed for processing by the manufacturing system. The test detector may be a first imaging device, such as a camera, for example a high magnification camera, and the work piece detector may be a second imaging device, such as a camera, for example a high magnification camera. By detecting the feature, position and/or orientation of the work piece can be precisely determined using image processing, where the image may be an image in ordinary visible light or an image or signature of another kind. The work piece detector and the test detector are independently movable, positionable, and operable to allow concurrent detection of test material and detection of the feature of the work piece in order to optimize preparation of the manufacturing system to process the work piece. The controller of the manufacturing system, or the controller of the work piece support, can be configured to control the work piece support to perform the operations of part 304.

At 306, the test detector is calibrated. A test material is deposited on the test surface, and detected by the test detector to yield a first image. The same test material is also detected by the first reference detector to yield a second image. The first reference detector may be a third imaging device, such as a camera, for example a high magnification camera. The two images are compared, for example by creating data representing each image, using image processing or signal processing software, and comparing the data. The comparison yields a relationship between an image or signature captured by the test detector and an image or signature captured by the reference detector. The relationship can be used to define a relationship between the signal of the test location sensor and position of the test detector so that position of the test detector is known when the test detector detects the test material, and thus position of the test material can be known in a way that is directly comparable, without substantial error, to position of the dispenser unit when the test material is deposited. The controller of the manufacturing system can be configured to control the test unit, the dispenser unit, and the first reference detector to perform the operations of part 306, of the controller of the manufacturing system can interact with controllers of the test unit and the dispenser unit to perform such operations.

At 308, the work piece detector is calibrated. A location reference, which is a stationary component of the manufacturing system, provides a fixed point of reference to calibrate precision positioning of various components of the manufacturing system. The manufacturing system can have a single location reference or multiple location references. Where thermal variation can cause significant dimensional change, use of multiple location references can be affected by such errors because the relative positions of the multiple location references can change. In such circumstances, calibrating sensors to the multiple location references can provide temperature calibration of the components of the manufacturing system. Where a component cannot be directly calibrated using a location reference of the manufacturing system, for example because the component cannot interact with the location reference in a way that provides calibration, the component can interact with another component of the manufacturing system that can be calibrated using the location reference. Thus, one component's calibration to a standard location can be used to calibrate another component of the manufacturing system.

If the work piece detector can be positioned to detect the location reference, the work piece detector can detect the location reference, for example by capturing an image of the location reference, a position of the location reference can be determined and related to a signal from the location sensor of the work piece detector, and a relationship defined between the signal of the location sensor of the work piece detector and position of the work piece detector. The relationship can then be used to ascertain position of the work piece detector from the signal of the location sensor.

If the work piece detector cannot be moved to detect the location reference, the first reference detector, coupled to the dispenser unit, and the work piece detector can be used to detect the same feature of the work piece. The position of the first reference detector is known from the signal of the dispenser location sensor and the calibration of the first reference detector using the location reference. By comparing the images, for example the precise position of a feature identified in each image, a relationship between the signal of the work piece location sensor and position of the feature in the image can be defined that allows position of the work piece detector to be precisely known in a way that is directly comparable to the position of the dispenser unit (and other similarly calibrated components), for example in a common coordinate system. The controller of the manufacturing system, or another controller, can be configured to perform the operations of part 308.

At 310, the first reference detector is calibrated to define a relationship between a signal of the dispenser location sensor and a position of the first reference detector. The first reference detector is positioned to detect the location reference, and a position of the location reference is determined, for example by processing an image using the processor of the controller. The relationship between the signal of the dispenser location sensor and the position of the location reference is then determined. The controller can be configured to perform the operations to define the relationship and calibrate the first reference detector. In this way, the position of the first reference detector is calibrated to a stationary location reference of the manufacturing system, and by the operations of part 306, the position of the test detector is also calibrated to the same stationary location reference using calibration of the first reference detector. The controller of the manufacturing system, or the controller of the dispenser unit, can be configured to perform the operations of part 308.

Here, the first reference detector is calibrated to the location reference of the manufacturing system and is used to calibrate at least one other component of the manufacturing system. This illustrates the concept of choosing a component to be a standard calibration component, calibrated to a fixed reference, which can be used to calibrate other components so that all components can be accurately and precisely operated according to a common plan. Using such methods, it is not necessary for all components to be directly calibrated to a standard location, so long as errors between the components are small enough to be ignored or are canceled out by interoperation of the components.

The accuracy and precision of the sensors and detectors, and of parameters derived from signals and data obtained using the sensors and detectors, determines the precision with which the various calibration relationships can yield position information. Sensors, detectors, and methods can be selected to yield arbitrary precision in determination of position of the various components of the manufacturing system, and controllers can be configured to obtain, and then apply, the calibration relationships repeatedly. For example, the dimensions and physical properties of components of the manufacturing system can drift over time, for example from thermal cycling. The method 300 can be performed repeatedly, at will, to re-define calibration relationships to maintain capability of the manufacturing system to process work pieces with precision.

It should be noted that the work piece support can also be calibrated by similar means. As noted above, a work piece support location sensor can be used to signal the position of the work piece support, and a second reference detector can be coupled to the work piece support to enable calibration of the work piece support to precisely determine position of the work piece support from the signal provided by the work piece support location sensor. The work piece support can be moved to place the location standard, or another location standard, within detection range of the second reference detector. Alternately, the work piece support and the dispenser unit can be positioned to detect the same accessible feature, for example a feature of a work piece. The first reference detector, calibrated using a location reference, and the second reference detector can detect the feature, and a data representation of the feature obtained from each reference detector can be compared, for example by a controller of the manufacturing system. Where the position of the first reference detector is known, a relationship between the signal of the work piece support location sensor and the position of the work piece support, can be defined with precision in a way that is directly comparable to positions of other components of the manufacturing system.

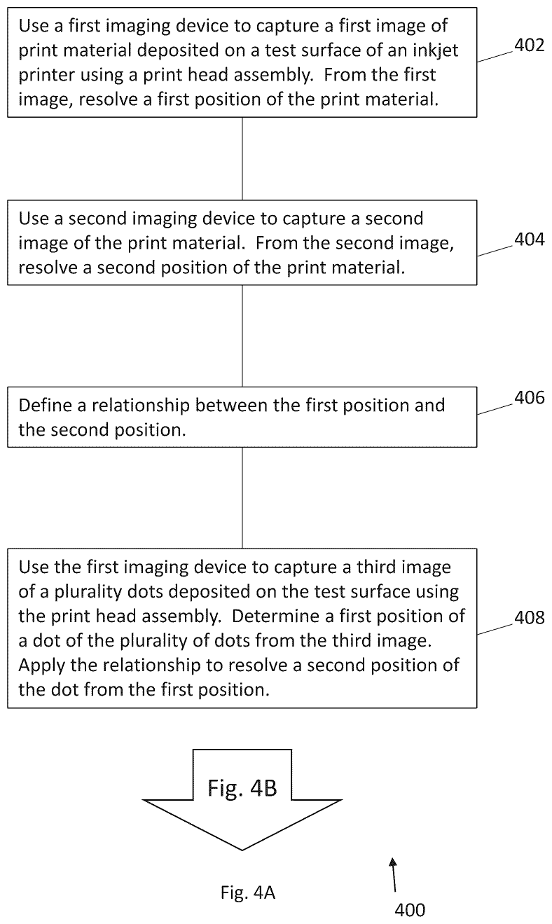

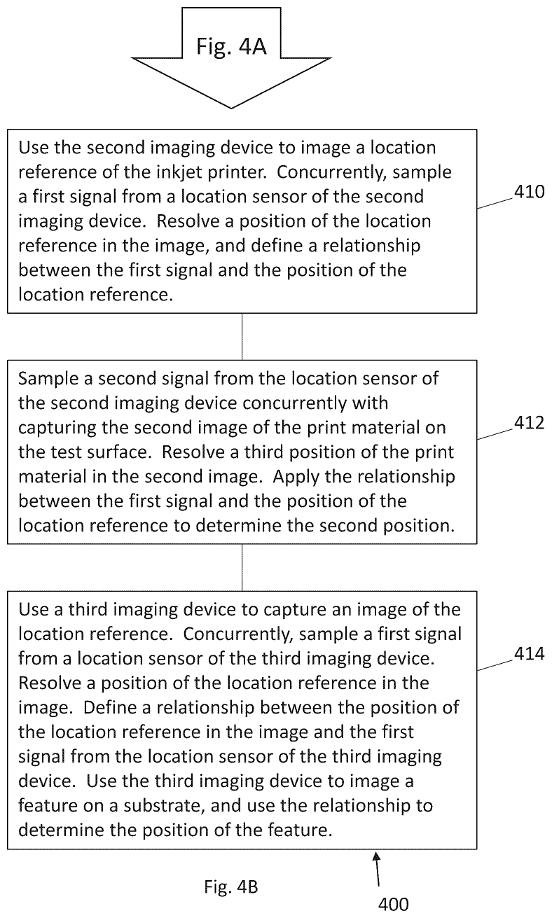

FIGS. 4A and 4B are flow diagrams summarizing parts of a method 400 according to another embodiment. FIG. 4A shows one part of the method and FIG. 4B shows another part of the method that cannot fit on the page of FIG. 4A. The method 400 is a method of operating an inkjet printer, such as the inkjet printer 200 of FIG. 2. In general, an inkjet printer that can be used to practice the method 400 has a substrate support and a print head assembly coupled to a support that allows the print head assembly to be positioned to deposit print material on a substrate disposed on the substrate support. To test performance of the print head assembly, the inkjet printer has a droplet placement analyzer for determining performance characteristics of the print head assembly so that print material can be placed on a substrate accurately and precisely. The droplet placement analyzer has a test surface to receive print material from the print head assembly and an imaging device to image the print material on the test surface. From the image of the print material captured by the imaging device of the droplet placement analyzer, performance characteristics of the print head assembly can be derived. For example, if the precise position of nozzles of the print head assembly is known at the time the print material is deposited on the test surface, the position of dots, for example, of print material on the test surface can be precisely ascertained by processing a high magnification image of the print material on the test surface, and a relationship between the position of a nozzle and the deposited position on a substrate of a drop from the nozzle can be determined. The relationship can then be used to plan, accurately and precisely, printing on a substrate.

The print material may be printed on the test surface in a pattern that is too large to be imaged in a single image, so the imaging device may be supported on a movable support to position the imaging device to capture multiple images. The movable support has a location sensor to signal position of the imaging device. The movable support typically has a range of motion that enables positioning the imaging device to capture images of the entire print material pattern, but might not have a range of motion that provides access to a location standard to calibrate the location sensor.

The print head assembly usually has a reference imaging device that can be used to calibrate various components of the inkjet printer. Thus, the imaging device of the droplet placement analyzer is a first imaging device and the reference imaging device is a second imaging device of the inkjet printer. The reference imaging device is attached to the print head assembly, which is movably coupled to the print head assembly support. The reference imaging device may be a high magnification camera or other suitable imaging device to provide high quality images for various purposes including position determination and calibration, substrate inspection, and substrate position calibration. The print head assembly is coupled to the print head assembly support by a motion system that has a print head assembly location sensor to signal location of the print head assembly on the print head assembly support.

Referring to FIG. 4A, at 402, the first imaging device is used to capture a first image of print material deposited on the test surface, and a first position of the print material is resolved from the first image, for example using image processing software executed by a digital processor. The processor may be a component of a controller of the inkjet printer, as described elsewhere herein.

At 404, the second imaging device is used to capture a second image of the print material. The print head assembly is moved to place the print material within the imaging field of the second imaging device. Where the first or second imaging device cannot image the entire pattern of print material, the same portion of the print material is imaged so that data from the images of the imaging devices can be compared. A second position of the print material is resolved from the second image by similar means.

At 406, a relationship is defined between the first position and the second position so that the relationship can be used to compare the position of the first imaging device to the print head assembly. For example, using the relationship the position of the first imaging device and the position of the print head assembly can be expressed in common units or coordinates.

At 408, the first imaging device is used to capture a third image of a plurality of dots deposited on the test surface using the print head assembly. A first position of a dot of the plurality of dots is determined by analyzing the third image, for example using image processing software executed by the controller of the inkjet printer. The relationship of 406 is then applied to resolve a second position of the dot. The first position may be a position in a frame of reference of the first imaging device, for example a coordinate location within the third image. The second position may be a position in a global or common coordinate system of the inkjet printer. Using the relationship to transform the first position from a local coordinate system to a second position in a global coordinate system allows the position of the dots deposited on the test surface to be compared to position of the nozzles that deposited the dots.

While this method is described in the context of printing dots of print material, the print material can be deposited in any convenient format, dots, lines, or shapes such as squares, rectangles, cross or plus shapes, or other shapes. More than one type of shape can be printed and then imaged to ascertain position relationships between components of a printer.

Referring now to FIG. 4B, at 410, the second imaging device can be used to image a location reference of the inkjet printer. Concurrently with capturing the image of the location reference, a first signal can be acquired from the location sensor of the second imaging device. A position of the location reference in the image is resolved, and a relationship between the first signal and the position of the location reference can be defined.

The location reference, as noted elsewhere herein, is a stationary object of the inkjet printer that has a known position, for example in a global or common coordinate system of the inkjet printer. That known position can be related to the first signal of the location sensor, so that the relationship between the first signal and the position of the location reference can be used to determine the location of the second imaging device from the first signal in the global coordinate system. Since the second imaging device is attached to the print head assembly, the location of the print head assembly, and any attached components thereof, such as nozzles of the print head assembly, can be precisely determined from the first signal.

At 412, a second signal is acquired from the location sensor of the second imaging device concurrently with capturing the second image of the print material on the test surface. To determine the second position, a third position of the print material in the second image is ascertained. This can be a position in a local coordinate system of the second imaging device and/or a position in a coordinate system of the image. The relationship between the first signal from the location sensor of the second imaging device and the position of the location reference, which may be a calibration function of the second imaging device, is then used to determine the second position.

A third imaging device can be used in the inkjet printer to image a feature of a substrate disposed on the substrate support of the inkjet printer. The image of the feature can be used to ascertain a location and orientation of the substrate so a print plan for the substrate can be accurately and precisely executed. To relate positioning of the print head assembly to the ascertained precise position and orientation of the substrate, the location of the third imaging device must be known in a way that can be compared to the location of the print head assembly. The third imaging device is typically movable to facilitate imaging the feature of the substrate. The third imaging device is often supported on the same print support as the print head assembly by a motion system that includes a location sensor.

At 414, the third imaging device is used to capture an image of the location reference of the inkjet printer. Concurrently, a first signal is acquired from the location sensor of the third imaging device. A position of the location reference in the image of the location reference is resolved. This can be a position in a local coordinate system of the third imaging device or of the image itself. A relationship between the position of the location reference in the image and the first signal from the location sensor of the third imaging device is resolved, and that relationship can be used to resolve location of a feature imaged by the third imaging device. Particularly, when the third imaging device is used to image a feature of a substrate, the location of that feature can be known by acquiring a signal from the location sensor of the third imaging device concurrently with acquiring an image of the feature, resolving a position of the feature in the image, and applying the relationship between the first signal and the position of the location reference. The location thus resolved is comparable to location or position of the print head assembly resolved from a signal of the location sensor of the print head assembly in common coordinates so that a print plan for the substrate can be defined.

Other components of the inkjet printer can be similarly calibrated, either using a location reference of the inkjet printer, or using the calibration of another component calibrated using the location reference. For example, the inkjet printer may have a substrate holder that moves and positions the substrate during processing. Because accurate and precise processing requires accurate and precise positioning and movement of the substrate, position of the substrate holder must be calibrated in the global coordinate system of the inkjet printer to be comparable to the position of the print head assembly. The substrate holder is provided with a location sensor and an imaging device, as with the third imaging device above. The imaging device of the substrate holder can then be used to image a location reference, or to image an object commonly with another imaging device calibrated using a location reference, like the second imaging device attached to the print head assembly. The position of the substrate holder can thus be determined from the location sensor of the substrate holder in the global coordinate system of the inkjet printer.

While the foregoing is directed to embodiments of one or more inventions, other embodiments of such inventions not specifically described in the present disclosure may be devised without departing from the basic scope thereof, which is determined by the claims that follow.

1. A manufacturing system, comprising:
a dispenser unit movably coupled to a support, the dispenser unit comprising a location sensor and a reference detector;
a test unit comprising a test surface for receiving material from the dispenser unit and an imaging device for imaging the material on the test surface;
a location reference mounted to a stationary component of the manufacturing system; and
a controller configured to:
control the dispenser unit and the reference detector to detect the location reference;
calibrate a position of the dispenser unit based on detecting the location reference;
control the test unit to image the material on the test surface;
control the dispenser unit and the reference detector to detect an aspect of the material on the test surface;
compare the image of the material captured by the test unit with the aspect of the material detected by the reference detector; and
calibrate the test unit based on the comparison.

2. The manufacturing system of claim 1, wherein the dispenser unit is movable along the support to process a work piece, and further comprising a work piece detector movably coupled to the support, wherein the controller is further configured to:
control the work piece detector to detect the location reference and calibrate a position of the work piece detector based on detecting the location reference; and
control the work piece detector to detect a position of a work piece.

3. The manufacturing system of claim 1, wherein the location reference is a first location reference, and further comprising a second location reference, wherein the controller is further configured to:
control the dispenser unit and the reference detector to detect the second location reference; and
calibrate the position of the reference detector based also on detecting the second location reference.

4. The manufacturing system of claim 3, further comprising:
controlling the dispenser unit and the reference detector to detect the first location reference and the second location reference at a plurality of different temperatures; and
calibrating the position of the reference detector based also on detecting the first location reference and the second location reference at the plurality of different temperatures.

5. The manufacturing system of claim 2, wherein the reference detector is a first reference detector, and further comprising a work piece support to position a work piece for processing by the dispenser unit, wherein the work piece support comprises:
a support member for engaging with the work piece; and
a second reference detector, wherein the controller is further configured to:
control the work piece support and the second reference detector to detect the location reference; and
calibrate a position of the work piece support based on detecting the location reference.

6. The manufacturing system of claim 1, wherein the reference detector is a high magnification camera.

7. A method of operating an inkjet printer, the method comprising:
using a first imaging device of an inkjet printer to capture a first image of a print material deposited on a test surface of the inkjet printer;
using a second imaging device of the inkjet printer to capture a second image of the print material on the test surface;
resolving a first position of the print material from the first image;
resolving a second position of the print material from the second image;
resolving a relationship of the first position to the second position;
using the first imaging device to capture a third image of a plurality of dots printed by the inkjet printer on the test surface;
resolving a first position of a dot of the plurality of dots from the third image; and
resolving a second position of the dot by applying the relationship to the first position of the dot.

8. The method of claim 7, wherein the relationship is a first relationship, and further comprising:
using the second imaging device to capture an image of a location reference of the inkjet printer;
concurrently with using the second imaging device to capture the image of the location reference, acquiring a first signal from a location sensor of the second imaging device;
resolving a position of the location reference in the image of the location reference; and
resolving a second relationship of the first signal to the position of the location reference based on the position of the location reference in the image of the location reference, wherein resolving the second position of the print material from the second image comprises:
concurrently with using the second imaging device to capture the second image of the print material on the test surface, acquiring a second signal from the location sensor of the second imaging device;
resolving a third position of the print material in the second image; and
applying the second relationship to the third position based on the second signal.

9. The method of claim 7, wherein the second imaging device is coupled to a print head assembly of the inkjet printer, the print head assembly comprising a print head location sensor, and resolving the second position of the print material from the second image comprises resolving a position in the second image and computing the second position from the position in the second image based on a signal from the print head location sensor.

10. The method of claim 7, further comprising:
using a third imaging device of the inkjet printer to capture an image of a feature of a substrate; and
resolving a position of the feature from the image of the feature.

11. The method of claim 10, wherein the relationship is a first relationship, and further comprising:
using the third imaging device to capture an image of a location reference of the inkjet printer;
concurrently with using the third imaging device to capture the image of the location reference, acquiring a first signal from a location sensor of the third imaging device;
resolving a position of the location reference in the image of the location reference; and
resolving a second relationship of the first signal to the position of the location reference based on the position of the location reference in the image of the location reference, wherein resolving the position of the feature from the image of the feature comprises:
concurrently with using the third imaging device to capture the image of the feature, acquiring a second signal from the location sensor of the third imaging device;
resolving a third position of the feature in the second image; and
applying the second relationship to the third position based on the second signal.

12. The method of claim 11, wherein the second imaging device is coupled to a print head assembly of the inkjet printer, the print head assembly comprising a print head location sensor, and resolving the second position of the print material from the second image comprises resolving a position in the second image and computing the second position from the position in the second image based on a signal from the print head location sensor, wherein the print head assembly and the third imaging device are each movably coupled to a print support of the inkjet printer.

13. The method of claim 9, further comprising resolving a performance characteristic of the print head assembly based on the second position of the dot.

14. A method, comprising:
using a first imaging device of a manufacturing system to image a test material deposited on a test surface of the manufacturing system by a dispenser unit of the manufacturing system;
concurrently with using the first imaging device to image the test material, using a second imaging device of the manufacturing system to image a feature on a work piece disposed on a work piece support of the manufacturing system;
calibrating the first imaging device by comparing a first image, captured by the first imaging device, of a calibration material deposited on the test surface with a second image of the calibration material captured by a third imaging device of the manufacturing system coupled to the dispenser unit;
calibrating the second imaging device based on a location reference of the manufacturing system; and
calibrating the third imaging device based on the location reference.

15. The method of claim 14, wherein the location reference is a first location reference, and calibrating the second imaging device is also based on the second location reference.

16. The method of claim 15, wherein the second imaging device is calibrated based on the first location reference, the second location reference, and a plurality of temperatures.

17. The method of claim 16, wherein the dispenser unit is movable along a support through a range of motion, and the first location reference and the second location reference are located at two extremities of the range of motion of the dispenser unit.

18. The method of claim 14, wherein the third imaging device is coupled to the dispenser unit along with a location sensor, and calibrating the third imaging device comprises capturing an image of the location reference using the third imaging device, determining a position of the location reference in the captured image, concurrently with capturing the image of the location reference, acquiring a signal from the location sensor, and relating the signal from the location sensor to the position of the location reference in the captured image.

19. The method of claim 14, wherein comparing the first image with the second image comprises resolving a calibration relationship of the first imaging device with the third imaging device.

20. The method of claim 14, further comprising determining a position of the dispenser unit, at the time the calibration material is deposited on the test substrate, based on the calibration of the third imaging device.
